(19) United States
(12) Patent Application Publication
(10) Pub. No.: US 2022/0087490 A1
(43) Pub. Date: Mar. 24, 2022

(54) VACUUM CLEANER BAG AND VACUUM CLEANER

(71) Applicant: WOLF PVG GMBH & CO. KG, Minden (DE)

(72) Inventors: Wolfgang CZADO, Porta Westfalica (DE); Gerold SCHANDL, Minden (DE)

(73) Assignee: WOLF PVG GMBH & CO. KG, Minden (DE)

(21) Appl. No.: 17/424,957

(22) PCT Filed: Feb. 4, 2020
(86) PCT No.: PCT/EP2020/052701

§ 371 Date: Jul. 22, 2021

(30) Foreign Application Priority Data
Feb. 15, 2019 (DE) 10 2019 103 908.8

(51) Int. Cl. A47L 9/14; B01D 46/02; B01D 39/08

(52) U.S. Cl. CPC A47L 9/1427; A47L 9/1481; B01D 46/02; B01D 39/08; B01D 2239/065; B01D 2271/02; B01D 2275/10; B01D 2239/0618; B01D 2279/55

(57) ABSTRACT

A vacuum cleaner has a vacuum cleaner bag having two layers made of filter material, which are joined together on at least three sides to form an inner chamber. An inflow opening is formed on a fourth side between the two layers, at least in regions, into which a connector for connecting to a vacuum cleaner can be inserted.

The present invention relates to a vacuum cleaner bag having two layers of filter material joined together at the edges on at least three sides, and to a vacuum cleaner.

EP 1 915 939 B1 discloses a filter bag for a vacuum cleaner, which is designed as a flat bag and in which two layers of filter material are welded together at the edges. In one of the layers, an inflow opening is punched out, on which a retaining plate is arranged for releasably fixing the vacuum cleaner bag in a vacuum cleaner. When inflated, the vacuum cleaner bag has a cushion shape, which is why the vacuum cleaner bag is poorly suited for small vacuum cleaners, for example cordless stick vacuums, despite good filter performance.

DE 10 2017 209 154 A1 discloses a hand-held vacuum cleaner that has a separator that operates according to the centrifugal force principle. Such separators are only suitable for separating coarse particles and only produce an optical cleanliness, since smaller particles are not retained. Despite these disadvantages, vacuum cleaners are offered on the market that have only a low suction power and a low separation efficiency for smaller particles, but have a particularly compact design due to the use of a small battery-powered suction unit. Such a floor vacuum cleaner is described, for example, in DE 10 2016 105 475 A1.

It is therefore an object of the present invention to create a vacuum cleaner bag that is also suitable for compact designs of vacuum cleaners and improves the separation performance of such vacuum cleaners.

This object is solved with a vacuum cleaner bag having the features of claim 1 as well as a vacuum cleaner with such a vacuum cleaner bag according to the features of claim 11.

In the vacuum cleaner bag according to the invention, two layers of filter material are joined together at the edges on at least three sides. The connection can optionally be made via a folded edge or a connecting seam, for example an adhesive seam or welded seam. The inner space formed in this way is accessible via an inflow opening which is formed on a fourth side between the two layers, at least in some areas, so that a connector can be inserted for connection to a vacuum cleaner. Thus, either no connecting seam at all can be provided on the fourth side, or this seam is arranged only over part of the length of the fourth side, and a further part is unconnected and forms an inflow opening. This allows the vacuum cleaner bag to be better adapted to elongated, compact chambers in a vacuum cleaner. In addition, the vacuum cleaner bag is easy to manufacture because punching out an inflow opening in one of the two layers of filter material and attaching the retaining plate are omitted.

Preferably, a closure element and/or a spring element is provided at the inflow opening. The closure element or the spring element can be arranged on a hem formed on the two layers at the inflow opening. The spring element can pretension the two layers into a closed position, so that after the vacuum cleaner bag is pulled off a connector, the inflow opening is closed via the spring element. Instead of the spring element or in addition to the spring element, a rope or a tensioning element can also be provided as a closure element, by means of which the inflow opening can be closed after it has been pulled off a connector of a vacuum cleaner. In addition, a Velcro fastener, profile fastener with two interlocking profiles, snap fasteners, rivets, magnets or a clamping strip can be used as a closure element. In addition, self-closing closures, such as are known from foil bags, can also be used. A pinch clip or a ring spring can also be used as a closure element.

Preferably, the spring element provided at the inflow opening of the vacuum cleaner bag is designed as a leaf spring. The leaf spring can have a kink at one end of the inflow opening, in particular a bend of about 180°. This allows a single spring element to pretension the inflow opening into the closed position. The leaf spring can be captively arranged in a hem of the vacuum cleaner bag.

For an optimized design of the shape of the vacuum cleaner bag, the inflow opening can extend completely over the length on the fourth side. This enables the formation of rather elongated vacuum cleaner bags which, viewed from above, have two longitudinal sides and two narrow sides, wherein the inflow opening is provided on one narrow side. The longitudinal sides may have a length that is at least three times longer, preferably at least four times longer, than the length of the narrow sides. Accordingly, a surrounding chamber of a vacuum cleaner may also be substantially tubular or hose-shaped.

To improve the seal in the region of the inflow opening, the filter material can have a sealing layer on the inside of the inflow opening, for example a bulky nonwoven or a strip of an elastic material, such as foam. The vacuum cleaner bag can incidentally be made of a nonwoven material, in particular a single-layer or multilayer nonwoven material.

The vacuum cleaner bag is preferably inserted into a chamber of a vacuum cleaner with a driven fan, in particular a vacuum cleaner electrically supplied by batteries. The vacuum cleaner can have a holding device that fixes the vacuum cleaner bag in the region of the inflow opening. In the vacuum cleaner, the vacuum cleaner bag is attached to a connector with the inflow opening. Holding means, such as grooves, slots, ribs, magnets or clamping elements, can be provided on this connector for better fixation.

The cross-section of the connector of the vacuum cleaner for attaching the vacuum cleaner bag preferably has a contour that deviates from the circular shape. The cross-sectional shape can be substantially oval, wherein the two ends on the narrow sides of the oval can also be pointed in order to optimize the seal between the connector and the vacuum cleaner bag.

Preferably, a mechanical ejector is provided on the vacuum cleaner, by means of which the vacuum cleaner bag can be stripped from the connector on the vacuum cleaner. This allows the vacuum cleaner bag to be ejected at an opening of the chamber without the user having to touch it. Alternatively, the vacuum cleaner bag can be manually removed from the connector and disposed of.

The invention is explained in more detail below by means of several exemplary embodiments with reference to the accompanying drawings, wherein:

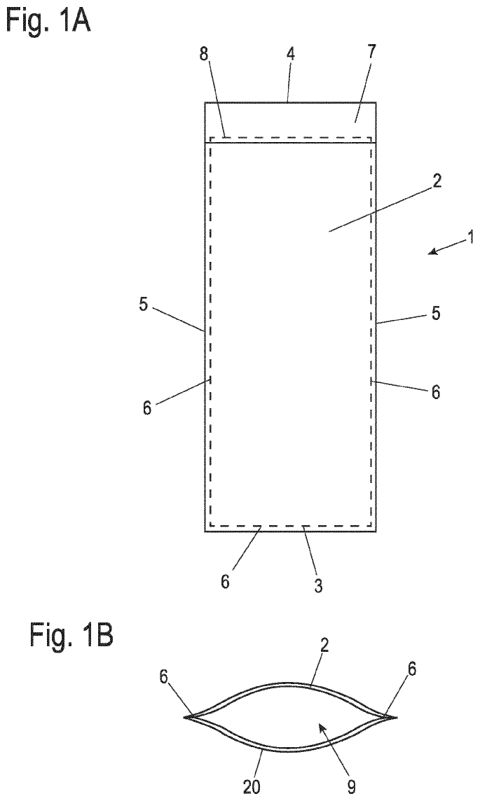

FIGS. 1A and 1B show two views of a vacuum cleaner bag according to the invention;

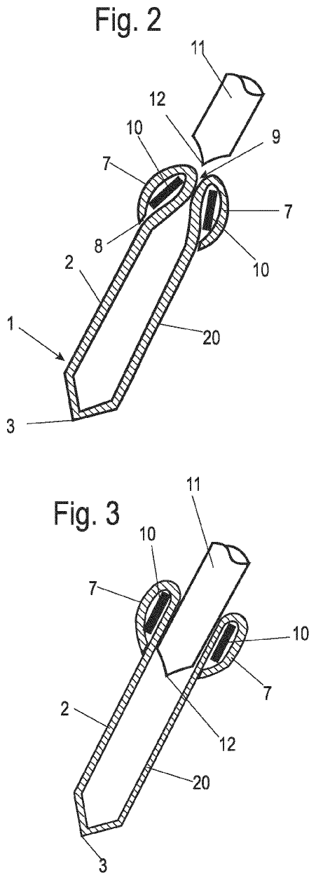

FIG. 2 shows a sectional view through the vacuum cleaner bag of FIG. 1 during insertion of a connector;

FIG. 3 shows a sectional view through the vacuum cleaner bag of FIG. 2 with the connector inserted;

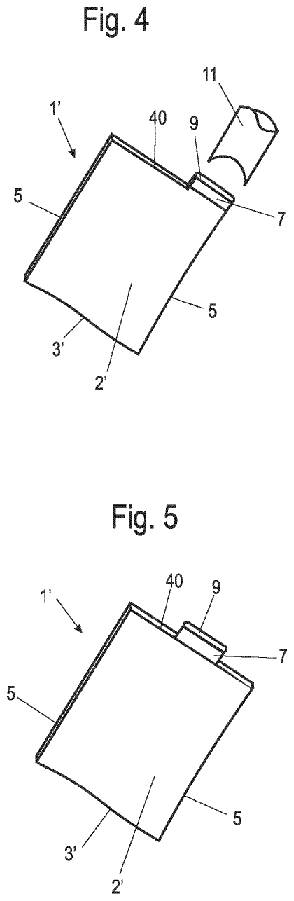

FIG. 4 shows a view of a modified vacuum cleaner bag before insertion of a connector,

FIG. 5 shows a view of a modified vacuum cleaner bag similar to FIG. 4 before insertion of a connector, and

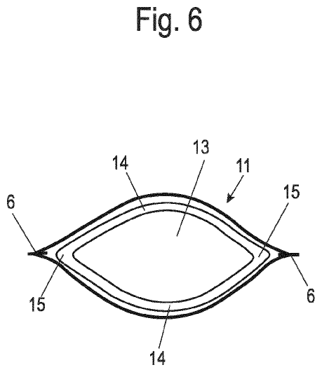

FIG. 6 shows a sectional view through the connector in the region of the inflow opening.

A vacuum cleaner bag 1 comprises two layers 2 of filter material, in particular of a single-layer or multi-layer nonwoven fabric or a paper, wherein the layers 2 can be of congruent design. Seen from above, each layer 2 is rectangular in shape, with two opposing narrow sides 3 and 4 and two longitudinal sides 5. The length of the longitudinal sides 5 is significantly longer than the length of the narrow sides 3 and 4, preferably at least three times as long.

The vacuum cleaner bag 1 is closed on three sides to form an inner space, wherein the two layers 2 of filter material are connected optionally by a folded edge or a connecting seam 6. The connecting seam 6 can be designed as a welded seam or adhesive seam. On the fourth side, the narrow side 4, an upper layer 2 and a lower layer 20 are not joined, so that an inflow opening 9 is formed between the two layers 2 and 20.

A hem 7 is formed on the narrow side 4 in the region of the inflow opening 9, which can be produced by folding over the filter material and fixing it with a seam 8. The hem 7 extends along the layer 2 and the layer 20 of filter material and forms a channel into which a closure element can be inserted. A spring element that pretensions the two layers 2 and 20 into a closed position can be provided as the closure element. For example, a metallic leaf spring can be used which has a kink in the region of one of the ends of a longitudinal side 5. Alternatively or additionally, another closure element, such as a rope or a clip made of plastic, can also be used.

In FIG. 2, the vacuum cleaner bag 1 is shown in section, and it can be seen that the layer 2 and the layer 20 surround an inner space in which dust can be collected. The inflow opening 9 is in a closed position in which the two layers 2 and 20 contact each other, as this is shown schematically. The closed position is held by a spring element 10, which is designed as a leaf spring that has a kink or bend of about 180° in the region of a longitudinal side 5. The spring element 10 is thereby held in the hem 7 at the inflow opening 9.

In order to place the vacuum cleaner bag 1 in a chamber of a vacuum cleaner, it is placed on a connector 11 which has, on its front side, one or more tips 12 which are insertable into the inflow opening 9.

In FIG. 3, the vacuum cleaner bag 1 is shown with the connector 11 inserted, wherein the layers 2 and 20 of the vacuum cleaner bag rest against the connector 11. The spring element 10 presses the layers 2 and 20 against the connector 11, thus providing a seal. In addition, a sealing element can be provided on the layers 2 and 20 of filter material in the region of the inflow opening around the connector 11, for example a bulky nonwoven fabric, a strip of foam or of another elastic material.

When the vacuum cleaner bag 1 is filled with dust, it can be removed from the connector 11 manually or via a stripping device, wherein the spring element 10 ensures automatic closure when the vacuum cleaner bag is removed. The vacuum cleaner bag 1 can then be disposed of.

FIG. 4 shows a modified vacuum cleaner bag 1′ which has an upper layer 2′ and a congruent lower layer which are joined together by a seam or folded edge on two longitudinal sides 5 and one narrow side 3′. A seam 40 is also provided on the further narrow side, extending over part of the length of the narrow side, for example between 20% to 80% of the length of the narrow side. An unconnected region of the layers 2′ on the fourth narrow side forms an inflow opening 9 into which a connector 11 of a vacuum cleaner can be inserted. The inflow opening 9 comprises a hem 7 at which a spring element 10 is arranged to pretension the inflow opening 9 into a sealed position, as explained in the exemplary embodiment of FIG. 1.

FIG. 5 shows a vacuum cleaner bag 1′ similar to FIG. 4, wherein the inflow opening 9 is arranged centrally on a narrow side and a seam 40 is provided on opposite sides of the inflow opening 9. An unconnected area of the layers 2′ on the narrow side forms the inflow opening 9, which is surrounded by a hem 7 with a spring element 10.

FIG. 6 shows a sectional view through the connector 11 in the region of the inflow opening 9, but without the spring element 10 and the hem 7. The connector 11 has a tubular channel 13 which is substantially oval in cross-section and has a greater extension in a longitudinal direction than perpendicular thereto. For this purpose, the connector 11 has two opposite wall sections 14 with a smaller radius of curvature than two tips 15, which are arranged adjacent to the connecting seams 6 on the longitudinal sides 5. This allows the vacuum cleaner bag 1 or 1′ to be better sealed in the region of the inflow opening 9.

In particular, the vacuum cleaner bag 1 can be inserted into a vacuum cleaner with an elongated housing shape, as known from battery-powered vacuum cleaners, also known as “cordless stick vacuums”.

### LIST OF REFERENCE NUMERALS

1, 1′ Vacuum cleaner bag
2, 2′ Layer
3, 3′ Narrow side
4 Narrow side
5 Longitudinal side
6 Connecting seam
7 Hem
8 Seam
9 Inflow opening
10 Spring element
11 Connector
12 Tip
13 Channel
14 Wall section
15 Tip
20 Layer
40 Seam

1: A vacuum cleaner bag (1, 1′) having two layers (2, 2′, 20) made of filter material which are connected to one another at the edges on at least three sides (3, 5) in order to form an inner chamber, wherein an inflow opening (9) is formed at least in regions on a fourth side (4) between the two layers (2, 2′, 20), into which inflow opening (9) a connector (11) can be inserted for connection to a vacuum cleaner.

2: The vacuum cleaner bag according to claim 1, wherein a hem is provided at the inflow opening (9) on the two layers (2, 2′, 20), into which a closure element and/or a spring element (10) is/are inserted.

3: The vacuum cleaner bag according to claim 1, wherein a spring element (10) is provided at the inflow opening (9), which pretensions the two layers (2, 2′, 20) into a closed position.

4: The vacuum cleaner bag according to claim 2, wherein the spring element (10) is designed as a leaf spring which is bent through approximately 180° at the edge of the inflow opening (9).

5: The vacuum cleaner bag according to claim 1, wherein the inflow opening (9) extends completely over the length of the fourth side (4).

6: The vacuum cleaner bag according to claim 1, wherein the four sides of the vacuum cleaner bag comprise two longitudinal sides (5) and two narrow sides (3, 4), as seen in plan view, and the inflow opening (9) is provided on one of the narrow sides (4).

7: The vacuum cleaner bag according to claim 6, wherein the longitudinal sides (5) are at least three times longer than the narrow sides (3, 4).

8: The vacuum cleaner bag according to claim 1, wherein a sealing layer, in particular made of a bulky nonwoven, is provided on an inside of the inflow opening (9).

9: The vacuum cleaner bag according to claim 1, wherein the filter material is made of a single-layer or multilayer nonwoven fabric.

10: The vacuum cleaner bag according to claim 1, wherein at least one hook-and-loop type fastener, profile fastener with two interlocking profiles, a snap fastener, a rivet, a magnet, a clamping strip, a pinch clip and/or an annular spring is provided for closing the inflow opening (9).

11: A vacuum cleaner comprising a driven fan and a substantially tubular chamber for accommodating a vacuum cleaner bag according to claim 1.

12: The vacuum cleaner according to claim 11, wherein the vacuum cleaner has a holding device which fixes the vacuum cleaner bag (1, 1′) in the region of the inflow opening (9).

13: The vacuum cleaner according to claim 11, wherein holding means in the form of grooves, slots, ribs, magnets and/or clamping elements are provided on a connector of the vacuum cleaner for fixing the vacuum cleaner bag (1, 1′).

14: The vacuum cleaner according to claim 11, wherein the connector, at least in the region of the inflow opening in an inserted position, is substantially oval in cross-section.

15: The vacuum cleaner according to claim 11, wherein the vacuum cleaner has a mechanical ejector that is configured for stripping the vacuum cleaner bag (1, 1′) from the connector.
